(19) United States
(12) Patent Application Publication
(10) Pub. No.: US 2014/0309341 A1
(43) Pub. Date: Oct. 16, 2014

(54) INJECTION-MOLDED PART, COMPOUND AND PRODUCTION METHOD

(71) Applicant: David Ribaric, Koln (DE)

(72) Inventor: David Ribaric, Koln (DE)

(73) Assignee: JOHNSON CONTROLS GMBH, Burscheid (DE)

(21) Appl. No.: 14/240,700

(22) PCT Filed: Jul. 4, 2012
(86) PCT No.: PCT/EP2012/002798

§ 371 Date: Jun. 4, 2014

(30) Foreign Application Priority Data
Aug. 25, 2011 (DE) 10 2011 111 169.0

(51) Int. Cl. C08L 23/12; C08L 1/02; B29C 45/00

(52) U.S. Cl. CPC C08L 23/12; B29C 45/0005; C08L 1/02
USPC 524/35; 264/328.18

(57) ABSTRACT

A cellulose-based natural fiber is added to an injection-molded plastic part, especially a fitting for the interior of a motor vehicle. In this manner, the strength of the part is increased and the fibers do not show on the surface.

The invention pertains to an injection-moulded part of plastic, particularly a fixture for the interior of a motor vehicle, wherein a fiber is added to the plastic. The invention furthermore pertains to a compound for manufacturing the injection-moulded part, as well as to a method for producing the injection-moulded part.

An injection-moulded part of this type and a method for its manufacture are known from EP 0782909 B1. In this case, glass fibers are admixed to the plastic in order to thusly increase the strength of the injection-moulded part manufactured of plastic.

However, glass fibers are only suitable for use as a filler in visible fixtures to a limited extent because they are apparent on the visible surface. This occurs, in particular, in the infusion area or on the weld lines. Alternatively, talcum is frequently used as filler in such instances. However, the strength of plastics with talcum is usually comparatively low.

The invention is based on the objective of developing an injection-moulded part of the initially cited type that has an adequate strength, but in which the fibers are not apparent or only marginally apparent on the surface.

With respect to an injection-moulded part of plastic, particularly a fixture for the interior of a motor vehicle, in which a fiber is added to the plastic, it is proposed, according to the invention, that the fiber added to the plastic is a cellulose-based natural fiber. Such fibers are softer and more flexible than glass fibers and therefore much less apparent on the surface. This advantageously makes it possible to manufacture flat surfaces that are free of apparent fibers. However, the reinforcing effect is superior to that of powdery fillers such as talcum. This means that the wall thicknesses can be reduced such that the weight of the components decreases. These fibers furthermore consist of renewable raw materials and can be thermally disposed without any problems. In addition, the wear on the moulds and injection moulding machines is reduced. The term natural fiber refers to a fiber that is manufactured of a natural product, in this case wood.

In a preferred embodiment, the fiber added to the plastic consists of Lyocell. Lyocell is a cellulose-based regenerated fiber that is industrially manufactured in accordance with the direct solvent process. One suitable fiber of this type, for example, is the fiber “TENCEL®” of the firm Lenzing. The fibers preferably have a thickness of 1 to 7 dtex (grams per 10,000 m length of thread) and are cut to a length between 15 and 75 mm.

Fibers with a thickness of 1.3 dtex preferably have an elongation at fracture of about 13% and a strength of about 37 cN/tex. Fibers of this type make it possible to achieve the desired properties, namely a sufficient strength and an adequate flexibility, such that a surface without visibly apparent fibers is created.

The fibers preferably have a diameter of 10 to 30 μm and are respectively composed of a bundle of macro-fibrils with diameters between 0.5 and 1 μm. The macro-fibrils are composed of micro-fibrils with diameters between 0.1 and 0.2 μm and the micro-fibrils are preferably composed of nano-fibrils with diameters between 10 and 100 nanometers. All in all, the preferred fiber used therefore has a total of four interleaved structural levels. These structure levels are the actual fibers, the macro-fibrils arranged therein, the micro-fibrils contained in the macro-fibrils and the nano-fibrils contained in the micro-fibrils. These structures are respectively aligned in the direction, in which the fiber extends.

A number of different compounds may be considered, as plastics. It is particularly preferred to use polypropylene.

Another aspect of the invention concerns making available a compound for producing injection-moulded parts that consist of a plastic and a cellulose-based natural fiber, particularly Lyocell.

Another aspect of the invention concerns making available a method for manufacturing an injection-moulded part according to one of the preceding claims, wherein said method is characterized in that the fibers are supplied to an injection moulding machine in the form of a granulate with high fiber content. The fibers consist of cellulose-based fibers, particularly Lyocell. The fibers are fed into the injection moulding machine in the form of a master batch.

1. An injection-moulded part comprising:
plastic; and
a fiber added to the plastic, wherein the fiber added to the plastic is a cellulose-based natural fiber.

2. The injection-moulded part according to claim 1, wherein the injection-moulded part has a flat surface that is free of apparent fibers.

3. The injection-moulded part according to claim 1, wherein the fiber added to the plastic consists of Lyocell.

4. The injection-moulded part according to claim 1, wherein the fibers have a thickness of 1 dtex to 7 dtex.

5. The injection-moulded part according to claim 1, wherein the fibers are cut to a length of 15 to 75 mm.

6. The injection-moulded part according to claim 1, wherein fibers with a thickness of 1.3 dtex have an elongation at fracture of about 13% and a strength of about 37 cN/tex.

7. The injection-moulded part according to claim 1, wherein the fibers have diameters between 10 and 30 μm.

8. The injection-moulded part according to claim 1, wherein the fibers contain longitudinally directed interior structures that in turn contain longitudinally directed interior structures.

9. The injection-moulded part according to claim 1, wherein the fibers are composed of a bundle of macro-fibrils with diameters between 0.5 and 1 μm.

10. The injection-moulded part according to claim 9, wherein the macro-fibrils are composed of micro-fibrils with diameters between 0.1 and 0.2 μm.

11. The injection-moulded part according to claim 10, wherein the micro-fibrils are composed of nano-fibrils with diameters between 10 and 100 nanometers.

12. The injection-moulded part according to claim 1, wherein the plastic consists of polypropylene.

13. A compound for manufacturing an injection-moulded part according to claim 1 wherein the compound contains a plastic and cellulose-based fibers.

14. The compound according to claim 13, wherein the fiber added to the injection-moulded part consists of Lyocell.

15. A method for producing an injection-moulded part according to claim 1, wherein the fibers are supplied to an injection moulding machine in the form of a granulate with high fiber content.
